(19) United States
(12) Patent Application Publication
(10) Pub. No.: US 2026/0023161 A1
(43) Pub. Date: Jan. 22, 2026

(54) SYSTEMS AND METHODS FOR ENTANGLEMENT ASSISTED QUANTUM RADAR

(71) Applicant: Arizona Board of Regents on Behalf of the Univeristy of Arizona, Tucson, AZ (US)

(72) Inventor: Ivan B. Djordjevic, Tucson, AZ (US)

(21) Appl. No.: 18/993,545

(22) PCT Filed: Jul. 18, 2023
(86) PCT No.: PCT/US23/70458

§ 371 Date: Jan. 11, 2025

Related U.S. Application Data
(60) Provisional application No. 63/390,088, filed on Jul. 18, 2022.

(51) Int. Cl. G01S 7/41; G01S 7/02; G01S 7/03; G01S 13/00; G01S 13/02; G01S 13/04; G01S 13/87

(52) U.S. Cl. CPC G01S 7/418; G01S 7/023; G01S 7/03; G01S 13/003; G01S 13/04; G01S 13/87; G01S 2013/0236

(57) ABSTRACT

Entanglement is a unique quantum information processing (QIP) feature. Entanglement can be used to implement quantum sensors with improved sensitivity over classical sensors. Disclosed are systems and techniques for entanglement assisted (EA) bistatic quantum radar applications and EA joint monostatic-bistatic quantum radar applications. An EA bistatic quantum radar can include a wideband entangled source used as a transmitter, and an EA detector. An EA monostatic quantum radar can include a wideband entangled source integrated or combined with an EA detector. Optical phase conjugation can be performed on a transmitter side but not on the one or more receiver sides. Target detection can be performed based on analyzing reflected signal photons against locally stored idler photons that are entangled with the signal photons with the help of balanced homodyne detector.

### CROSS REFERENCE TO RELATED APPLICATIONS

This is a PCT application that claims benefit to U.S. provisional application Ser. No. 63/390,088 filed on Jul. 18, 2022 which is incorporated by reference in its entirety.

### FIELD

The present disclosure generally relates to quantum information processing (QIP), and in particular, relates to a system and associated method for entanglement assisted quantum radar.

### BACKGROUND

Quantum information processing (QIP) opens new avenues for numerous applications, including high-performance computing, high-precision sensing, and secure communications. Among various QIP attributes, entanglement is a unique QIP feature and may be used to implement quantum computers capable of solving problems that are numerically intractable for classical computers. Entanglement-based approaches may also lead to quantum-enhanced sensors with measurement sensitivities that exceed classical limits.

For example, entanglement represents a unique quantum information processing (QIP) attribute that can enable: (1) outperforming classical sensor sensitivity; (2) unconditional security for future communication networks; and (3) exceeding classical channel capacities. Additionally, pre-shared entanglement can enable distributed quantum sensing and/or secure distributed quantum computing.

One motivation behind quantum target detection studies is to outperform the quantum limit of classical sensors. For example, quantum radars outperform classical radars in terms of detection probability in low signal-to-noise ratio (SNR) regimes and in range estimation. Quantum radars have several advantages compared to corresponding classical radar counterparts: improved receiver sensitivity, better detection probability of targets (e.g., particularly in a low SNR regime), improved synthetic-aperture radar imaging quality, improved detection through clouds and fog (e.g., particularly when microwave photons are used), better resilience to jamming, higher cross-section, among others. Moreover, quantum radar signals are more difficult to detect compared to classical radar signals. Recently, two popular quantum radar designs have emerged: (i) the quantum radar employing Lloyd's quantum illumination sensing concept and (ii) the interferometric quantum radar.

It is with these observations in mind, among others, that various aspects of the present disclosure were conceived and developed.

### SUMMARY

The present disclosure provides a number of examples of an inventive concept including systems and methods for entanglement assisted quantum radar. In the context of the disclosed methods, devices, techniques, apparatus, systems, and so on, the terms “operable to,” “configured to,” and “capable of” used herein are interchangeable.

In a first set of illustrative examples, the present inventive concept is embodied as a method, comprising steps of: generating an entangled pair of photons comprising a signal photon and an idler photon; transmitting, using an integrated entanglement assisted (EA) transmitter, a quantum radar probe based on the signal photon of the entangled pair, wherein the integrated EA transmitter generates the radar probe by performing optical phase conjugation (OPC) for the signal photon; storing the idler photon of the entangled pair as a local reference in a quantum memory; detecting a radar return, wherein the radar return is associated with a reflection of the quantum radar probe; analyzing the reflection of the quantum radar probe and the idler photon stored as the local reference; and based on the analyzing, determining whether the quantum radar probe was reflected by a target.

In a second set of illustrative examples, the present inventive concept is embodied as a method, comprising steps of: generating a first entangled pair of photons comprising a first signal photon and a first idler photon; generating a second entangled pair of photons comprising a second signal photon and a second idler photon; storing the first and second idler photons as a first and second local reference, respectively, in a quantum memory; transmitting, using a first integrated entanglement assisted (EA) transmitter: a first quantum radar probe generated based on performing continuous-wave spontaneous parametric down conversion (SPDC), followed by optical phase conjugation (OPC) for the first signal photon, wherein the transmitting is performed using an expanding telescope; and a second quantum radar probe generated based on performing the SPDC, followed by the OPC for the second signal photon, wherein the transmitting is performed using an expanding telescope; detecting, using the first EA receiver, a reflection of the first signal photon; detecting, using a classical coherent receiver separate from the first integrated EA transmitter, a forward scattering of the second signal photon; analyzing the reflection of the first signal photon and the first idler photon stored as local reference using a homodyne balanced detector, and analyzing the forward scattered second signal photon and the second idler photon stored as local reference using the homodyne balanced detector; and based on the analyzing, determining whether the first and second quantum radar probes were reflected by a target.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1 is a simplified diagram showing an example entanglement assisted (EA) joint monostatic-bistatic quantum radar system and technique;

FIG. 2 is a simplified diagram showing an example EA monostatic quantum radar system and technique;

FIG. 3 is a simplified diagram showing an example optical-parametric amplifier (OPA)-based EA target detection receiver;

FIG. 4 is a simplified diagram showing an example joint monostatic-bistatic LiNbO₃-based integrated EA transmitter with transmit side OPC;

FIG. 5 is a simplified diagram showing an example EA homodyne balanced detection receiver corresponding to direct return/forward scattered components;

FIG. 6 is a simplified diagram showing an example graph of detection probability vs. SNR [dB] for different radar detection schemes for an average number of thermal photons set to N_{b}=10;

FIG. 7 is a simplified diagram showing an example graph of detection probability vs. SNR [dB] for joint EA schemes for different direct return probe/forward scattered probe bosonic channel transmissivities;

FIG. 8 is a simplified diagram showing an example graph of detection probability vs. SNR [dB] for EA joint detection schemes for different idler channel transmissivities;

FIG. 9 is a simplified diagram showing an example graph of detection probability vs. SNR [dB] for EA joint detection schemes for a fixed idler channel transmissivity;

FIG. 10 is a simplified diagram showing an example of an EA bistatic quantum radar system and technique;

FIG. 11 is a simplified diagram showing an example operation principle of an optical-parametric amplifier (OPA)-based EA target detection receiver;

FIG. 12 is a simplified diagram showing an example LiNbO₃-based integrated EA transmitter with OPC implemented on the transmitter side;

FIG. 13 is a simplified diagram showing an example EA homodyne balanced detection receiver;

FIGS. 14(A-C) is a simplified diagram showing an example graph of detection probability vs. SNR [dB] for different radar detection schemes for various average numbers of thermal photons;

FIG. 15 is a simplified diagram showing an example graph of detection probability vs. SNR [dB] for an EA OPC technique for different values of main bosonic channel transmissivities;

FIG. 16 is a simplified diagram showing an example graph of detection probability vs. SNR [dB] for an EA OPC technique for different values of idler channel transmissivities.

FIG. 17 is a simplified block diagram of an example method associated with the systems described herein.

Corresponding reference characters indicate corresponding elements among the view of the drawings. The headings used in the figures do not limit the scope of the claims.

### DETAILED DESCRIPTION

### A: Entanglement Assisted Joint Monostatic-Bistatic Radars

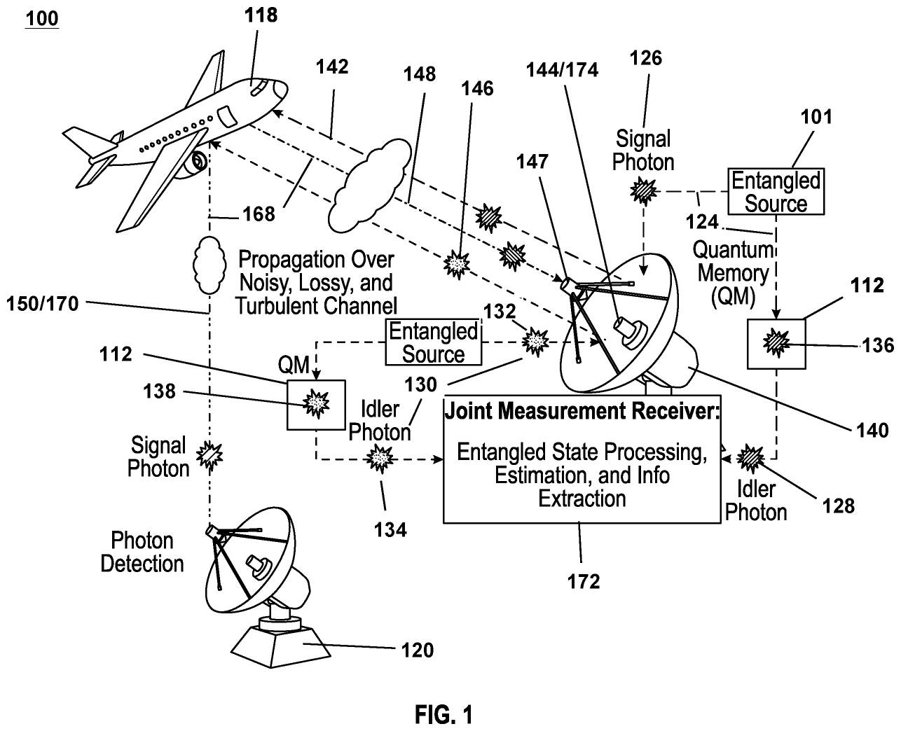

Aspects of the present disclosure provide systems and methods for an entanglement assisted (EA) joint monostatic-bistatic quantum radar detection scheme with a corresponding operational principle (hereinafter, system 100) being depicted in FIG. 1. A wideband entangled source 101 generates two entangled pairs of photons 124 and 130, each pair of entangled photons containing a signal photon 126 and 132 and an idler photon 128 and 134.

The idler photons 128 and 134 are kept in the quantum memories 112 of the receivers as a first local reference 136 and a second local reference 138. Both signal photons 126 and 132 are transmitted (e.g., the first and second quantum radar probes 142 and 146) over noisy, lossy, and atmospheric turbulent channel towards the target (e.g., the target 118 in the top left of FIG. 1). A directly reflected photon (e.g., reflected by or from the target, or otherwise based on an interaction with the target) is detected by the first radar receiver 147, while a forward scattered photon 150 is detected by the second radar receiver 120. The quantum correlation is utilized on receive sides to improve overall target detection probability. Inherent spatial diversity is exploited to improve the overall SNR.

To simplify design and at the same time improve the target detection probability, the system 100 applies optical phase conjugation (OPC) on the transmitter side 154 rather than on the receiver side. The entanglement-assisted (EA) detectors are based on classical coherent detection with an idler mode having the same role as a local oscillator (LO) laser signal. The EA joint target detection scheme implemented by the system 100 can be seen to significantly outperform coherent states-based quantum detection, EA monostatic, and classical radar counterparts. The EA joint target detection scheme is further evaluated herein by modelling both the directly reflected mode channel and the forward scattered mode channel as lossy and noisy Bosonic channels, respectively. Finally, the present discussion assumes that the distribution of entanglement over the idler channels is not perfect.

This disclosure is organized as follows. The EA monostatic radar concept is introduced in Sec. A-I and is used as a reference case to provide context for the system 100. The EA joint monostatic-bistatic radar scheme implemented by the system 100, employing the OPC on transmitter side and coherent detection on receiver sides, is described in Sec. A-II. Both directly reflected (e.g., return) signal mode and forward scattered signal mode channels are modeled as lossy and noisy Bosonic channels. The idler channels are also modelled as less lossy and less noisy Bosonic channels compared to the signal channels. In Sec. A-III the detection probability performances of the system 100 employing the EA joint monostatic-bistatic radar target detection scheme are evaluated and compared against coherent states-based quantum detection, EA monostatic detection, and classical detection schemes.

### A-I. Entanglement Assisted Monostatic Radars

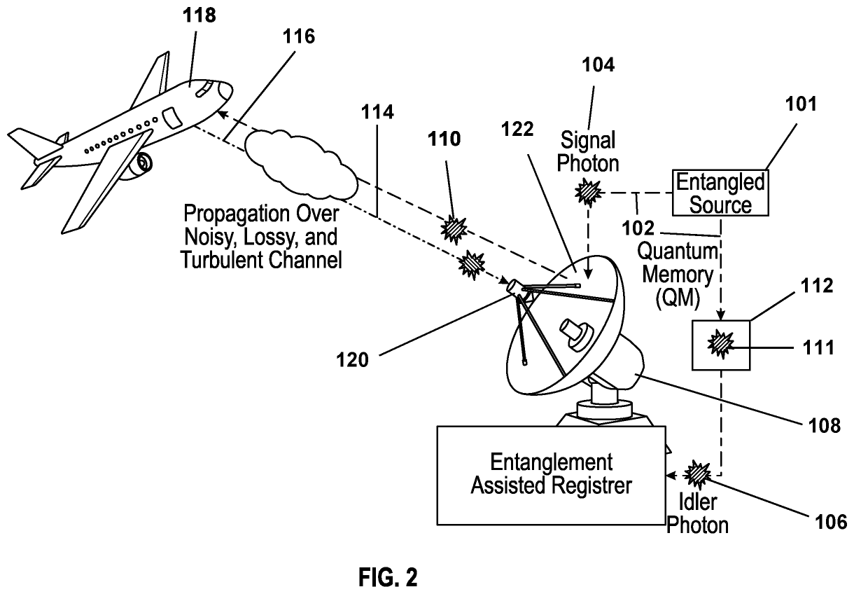

This section describes an example entanglement assisted (EA) monostatic radar target detection scheme, shown in FIG. 2, employing the Gaussian states generated through the continuous-wave spontaneous parametric down conversion (SPDC) process. The SPDC-based entangled source 101 represents a broadband source having D=TₘW i.i.d. (independent and identically distributed) signal-idler photon pairs, where Tₘ is the measurement interval and W is the phase-matching SPDC bandwidth. Each signal-idler photons pair 102 (which for monostatic radar are denoted as red photons in FIG. 2) is a two-mode squeezed vacuum (TMSV) state whose representation in Fock basis is given by:

$${{{\vert Ψ 〉}_{s , i} = \frac{1}{\sqrt{{N}_{s} + 1}} {\sum }_{n = 0}^{∞} {( \frac{{N}_{s}}{{N}_{s} + 1} )}^{n / 2} \vert n 〉}_{s} \vert n 〉}_{i} , \qquad ( 1 )$$

$$Here , {N}_{s} = ( {\hat{a}}_{s}^{†} {\hat{a}}_{s} 〉 = 〈 {\hat{a}}_{i}^{†} {\hat{a}}_{i} 〉$$

is the mean photon number per mode, with corresponding signal 104 and idler 106 creation operators being denoted by

$${\hat{a}}_{s}^{†} and {\hat{a}}_{i}^{†} ,$$

respectively. The signal-idler entanglement is characterized by the phase-sensitive cross-correlation (PSCC) coefficient, defined as

$$〈 {\hat{a}}_{s} {\hat{a}}_{i} 〉 = \sqrt{{N}_{s} ( {N}_{s} + 1 )} ,$$

which can be considered as the quantum limit.

The TMSV state represents a pure maximally entangled zero-mean Gaussian state with the following Wigner covariance matrix:

$${Σ}_{T M S V} = [ \begin{matrix}( 2 {N}_{s} + 1 ) 1 & 2 \sqrt{{N}_{s} ( {N}_{s} + 1 )} Z \\ 2 \sqrt{{N}_{s} ( {N}_{s} + 1 )} Z & ( 2 {N}_{s} + 1 ) 1\end{matrix} ] , \qquad ( 2 )$$

Here, Z=diag(1, −1) denotes the Pauli Z-matrix and 1 denotes the identity matrix.

In the low-brightness regime Nₛ<<1, the PSCC is [symbol] âₛâᵢ [symbol] ≈\sqrt{Nₛ} that is much larger than the corresponding classical limit Nₛ. As described earlier, and referring back to FIG. 2, the entangled source 101 is used on the transmitter side 122 to generate a quantum correlated signal photon (e.g., probe 110) and an idler photon, which serves as a local reference 111 which can be stored using a variable optical delay line 164. The signal photon is transmitted by an EA transmitter 108 with the help of an expanding telescope 144 (e.g., with a large/wide field of view) over a noisy, lossy, and atmospheric turbulent channel towards the target 118. The reflected photon 116 (e.g., the radar return 114) is detected by the radar's receiver 120, and quantum correlation between the radar return and a retained reference (e.g., the idler photon 106) is exploited on the receiver side to improve the receiver sensitivity.

The interaction between the probe 110 (e.g., signal) photon and the target 118 can be described by a beam splitter of transmissivity T^{(r)}. Therefore, the radar transmitter-target-radar receiver (e.g., directly reflected mode) channel (e.g., direct return channel) can be modeled as a lossy thermal Bosonic channel:

$${\hat{a}}_{Rx}^{( r )} ( φ ) = \sqrt{{T}^{( r )}} {e}^{- j {φ}^{( r )}} {\hat{a}}_{s} + \sqrt{1 - {T}^{( r )}} {\hat{a}}_{b}^{( i )} , \qquad ( 3 )$$

$$Here , {\hat{a}}_{b}^{( r )}$$

is a background (thermal) state of the direct return channel with the mean photon number being

$$( 1 - {T}^{( r )} ) 〈 {\hat{a}}_{b}^{( r ) †} {\hat{a}}_{b}^{( r )} 〉 = {N}_{b} .$$

Signal-mode phase shift introduced by the target and channel is denoted as φ^{(r)}. The idler-mode channel is also modelled as the lossy and noisy Bosonic channel:

$${\hat{a}}_{Rx , idler} = \sqrt{{T}^{( i )}} {\hat{a}}_{i} + \sqrt{1 - {T}^{( i )}} {\hat{a}}_{b}^{( i )} , \qquad ( 4 )$$

Here, T⁽ⁱ⁾ is transmissivity of the idler channel and

$${\hat{a}}_{b}^{( i )}$$

is the annihilation operator of the background (e.g., thermal) mode of the idler channel with the mean photon number being

$$( 1 - {T}^{( i )} ) 〈 {\hat{a}}_{b}^{( i ) †} {\hat{a}}_{b}^{( i )} 〉 = {N}_{b}^{( i )} .$$

The radar returned probe 110 and retained reference (stored idler 111) can be described by the following covariance matrix:

$${Σ}_{t} = [ \begin{matrix}( 2 {N}_{s} + 1 ) 1 & 2 \sqrt{{T}^{( r )} {T}^{( i )} {N}_{s} ( {N}_{s} + 1 )} Z {δ}_{1 t} \\ 2 \sqrt{{T}^{( r )} {T}^{( i )} {N}_{s} ( {N}_{s} + 1 )} Z {δ}_{1 t} & ( 2 {N}_{s}^{( r )} + 1 ) 1\end{matrix} ] . \qquad ( 5 )$$

$$Here , {N}_{s}^{( r )} = ( {T}^{( i )} {N}_{s} + {N}_{b}^{( i )} ) {T}^{( r )} + {N}_{b} .$$

The target indicator is denoted as t. In the absence of the target, t=0 (and in this case the return signal does not contain a probe, just the background noise) and the covariance matrix is diagonal. On the other hand, in the presence of the target t=1 and antidiagonal terms (e.g., representing the quantum correlation between the signal and idler) are non-zero.

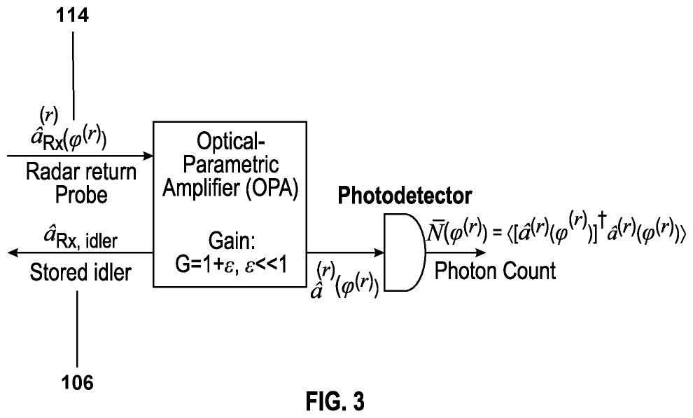

The EA monostatic radar receiver may use an optical parametric amplifier (OPA), shown in FIG. 3 (e.g., as an OPA-based EA target detection receiver), with a low gain G−1=ε<<1, to obtain:

$${\hat{a}}^{( r )} ( {φ}^{( r )} ) = \sqrt{G} {\hat{a}}_{Rx , idler} + \sqrt{G - 1} {\hat{a}}_{Rx}^{( r ) †} ( {φ}^{( r )} ) \qquad ( 6 )$$

for each signal-idler pair 102 of a given mode. The direct detection of the OPA has the following mean photon number:

$$\overline{N} ( {φ}^{( r )} ) = 〈 {[ {\hat{a}}^{( r )} {φ}^{( r )} ]}^{†} {\hat{a}}^{( r )} ( {φ}^{( r )} ) 〉 .$$

In some aspects, it can be seen that OPA-based EA receivers, for an ideal distribution of the idler (T⁽ⁱ⁾=1), provide ≤3 dB improvement over corresponding classical receivers. In the presence of experimental imperfections, the improvement was reduced down to 1 dB. Given that the OPC receiver outperforms the OPA receiver here, the system 100 employs an EA joint monostatic-bistatic target detection scheme that employs the OPC on transmitter side and classical coherent detection on both receiving ends.

### A-II. Proposed Entanglement Assisted Joint Monostatic-Bistatic Radar Detection Scheme

This section provides details about the system 100 that employs an entanglement assisted joint monostatic-bistatic radar detection concept (e.g., the system 100 shown in FIG. 1), which in some aspects can be based on the recently proposed EA communication system (see, for example, commonly owned U.S. Provisional Patent Application No. U.S. 63/352,540, the contents of which are herein incorporated by reference in their entirety). In some embodiments, multiple expanding telescopes 144 per transmitter 140 are used so that different portions of the target 118 can be illuminated. Alternatively, or additionally, multiple apertures 174 per expanding telescope can be used.

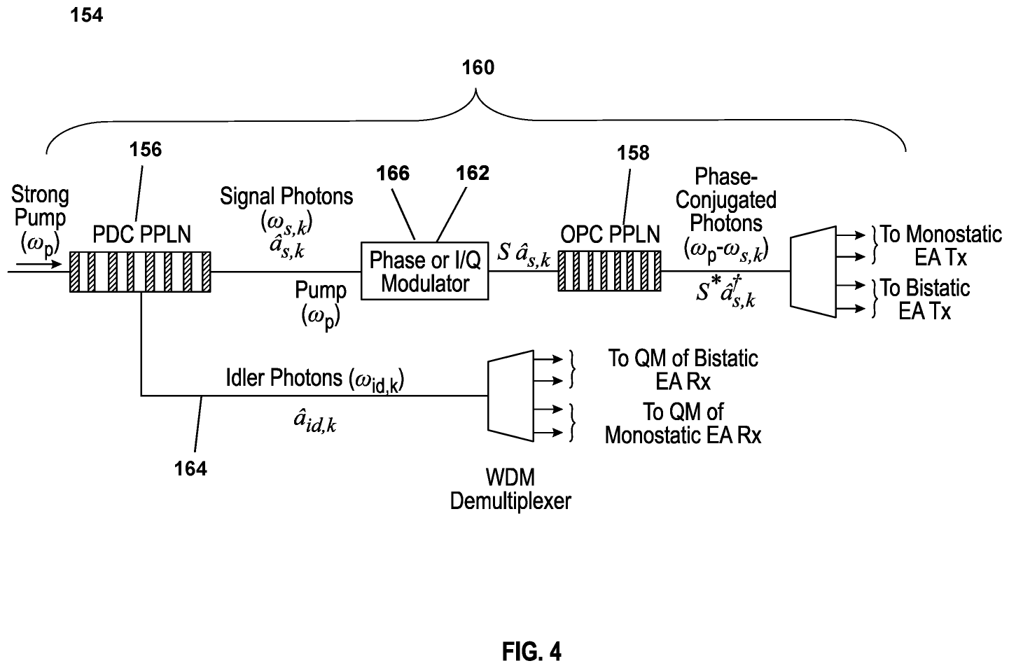

The presently disclosed joint monostatic-bistatic integrated (e.g., LiNbO₃ technology-based) EA transmitter 140, with transmit side OPC 158, is illustrated in FIG. 4. In particular, FIG. 4 depicts a joint monostatic-bistatic LiNbO₃ technology-based integrated EA transmitter with transmit side ODC. In FIG. 4, the PDC PPLN 156 element represents a parametric down conversion (PDC) periodically poled LiNbO₃ waveguide (PPLN); the OPC PPLN 158 element represents an optical phase conjugation (OPC) periodically poled LiNbO₃ waveguide (PPLN); and the QM elements represent quantum memories.

The phase modulator or I/Q modulator 166 and 162 can be optional. The system 100 applies an OPC operation through the difference frequency generation (DFG) process by using the periodically poled LiNbO₃ (PPLN) waveguide. In the first PPLN waveguide, the SPDC 156 concept is utilized to generate signal-idler photon pairs, which get separated by the properly designed Y-junction. Given that the SPDC is a wideband process, a large number of signal-idler photon pairs can be generated. Accordingly, subscript k is used to denote the kth signal-kth idler photon pair.

In the second PPLN, the DFG interaction of the pump photon ωₚ and signal photon ω_{s,k} takes place and the phase-conjugated (PC) photon at radial frequency ωₚ−ω_{s,k} is generated. The wavelength division (WDM) demultiplexer is then used to separate the signal/idler photons corresponding to monostatic and bistatic transmitters/receivers, as shown in FIG. 1.

As an illustrative example, for the strong pump at λₚ=780 nm, through the SPDC the following signal-idler pairs can be generated: (1) [the idler photon 1 at λ_{i,1}=1535 nm]−[the signal photon 1 at wavelength λ_{s,1}=1585.8 nm] and (2) [the idler photon 2 at λ_{s,2}=1545 nm]−[the signal photon 2 at wavelength λ_{s,2}=1575.3 nm].

After the OPC PPLN waveguide 158, the signal photon 1 interacts with the pump photon through DFG to get the PC signal photon at λ_{s,1pc}=1(1/λₚ−1/λ_{s,1})=1530 nm, which is the same wavelength as that of the idler photon 1. In similar fashion, after the OPC PPLN waveguide, the signal photon 2 interacts with the pump photon through DFG to get the PC signal photon at λ_{s,2pc}=1(1/λₚ−1/λ_{s,2})=1545 nm, representing the same wavelength as that of the idler photon 2.

In FIG. 4, s denotes a signal constellation point imposed by either the phase modulator or the I/Q modulator. For M-ary PSK, s is simply exp(jθ_{mod}), where θ_{mod}∈{0, 2π/M, . . . , (M−1)2π/M}.

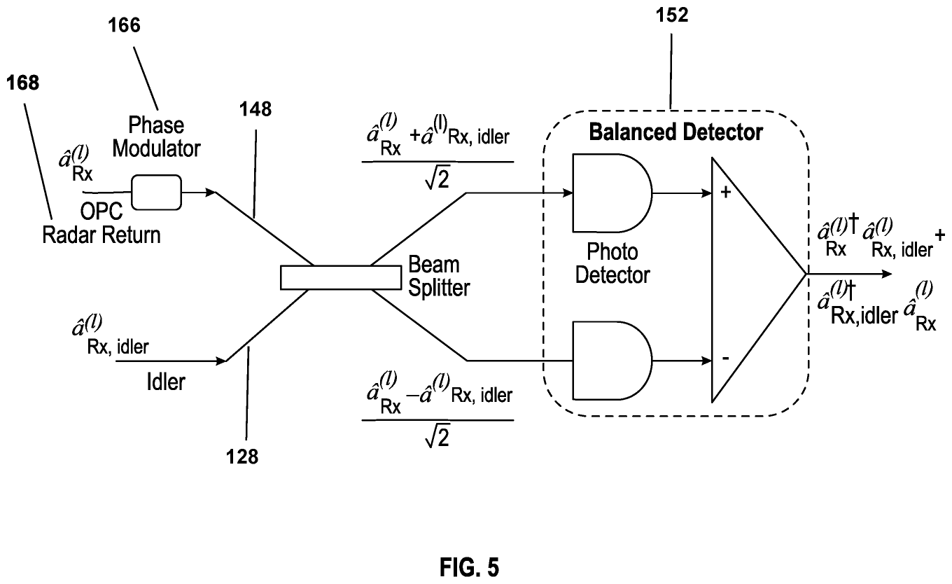

By performing the OPC on the transmitter side 154, a conventional-classical balanced coherent detection receiver 120 can be applied on the receive sides of monostatic and bistatic radars (see FIG. 1), with one such receiver being provided in FIG. 5. As illustrated, the OPC radar direct return probe/forward scattered probe and idler modes can be mixed on the balanced beam splitter, followed by two photodiodes. The idler mode for each EA detector serves as a local (e.g., oscillator) laser signal for the homodyne coherent detection.

For the transmit side OPC, the direct return channel rlforward scattering channel fs models can be represented by:

$${\hat{a}}_{Rx , k}^{( l )} ( {φ}^{( l )} ) = \sqrt{{T}^{( l )}} {e}^{j {φ}^{( l )}} {\hat{a}}_{s , k}^{( l ) †} + \sqrt{1 - {T}^{( l )}} {\hat{a}}_{b}^{( l )} , \qquad ( 7 )$$

Here, the superscript l is used to denote either the direct return channel (l=r) or the forward scattering channel (l=ƒs), while subscript k is used to denote the kth signal-idler photon pair.

The overall phase φ^{(l)} includes three components:

$${φ}^{( l )} = {θ}_{mod} + {ϑ}^{( l )} + {ϕ}^{( l )} , \qquad ( 8 )$$

where θ_{mod} is the modulation phase (when M-ary PSK is used), while ϑ^{(l)} denotes the phase-shift introduced by the target 118.

For the direct return probe 168, given that the distance between the transceiver and target is d, the phase shift introduced by the target will be ϑ^{(r)}=2kd, with k being the wave number related to the wavelength λ by k=2π/λ.

On the other hand, given that the distance between target and receiver in the forward scattering channel is D, the corresponding phase shift introduced by the target will be ϑ^{(ƒs)}=K(d+D). Finally, ϕ^{(l)} is the random phase shift introduced by the lth channel. The purpose of the transmit side phase modulator is to impose the sequence on transmitter side that will be used for estimation of the random phase shift and corresponding cancelation.

The balanced detector (BD) 152 photocurrent operator (e.g., assuming that the photodiode responsivity is 1 A/W), for the EA detector shown in FIG. 5, is given by:

$${\hat{ι}}_{BD}^{( l )} = {( {\hat{a}}_{Rx}^{( l )} )}^{†} {\hat{a}}_{Rx , idler}^{( l )} + {( {\hat{a}}_{Rx , idler}^{( l )} )}^{†} {\hat{a}}_{Rx}^{( l )} , l ∈ \{ r , fs \} \qquad ( 9 )$$

For the receive side phase modulator shift of Δ_{φ}=0 rad (e.g., see FIG. 5), in the presence of the target, the following BD photocurrent operator expectation is obtained:

$$〈 {\hat{ι}}_{BD , I}^{( l )} 〉 = 2 \sqrt{{T}^{( i )} {T}^{( l )} {N}_{s} ( {N}_{s} + 1 )} cos {φ}^{( l )} , l ∈ \{ r , fs \} \qquad ( 10 )$$

On the other hand, for the receive side phase modulator shift of Δ_{φ}=−π/2 rad, in the presence of target, the following BD photocurrent operator expectation is obtained:

$$〈 {\hat{ι}}_{BD , Q}^{( l )} 〉 = 2 \sqrt{{T}^{( i )} {T}^{( l )} {N}_{s} ( {N}_{s} + 1 )} sin {φ}^{( l )} , l ∈ \{ r , fs \} \qquad ( 11 )$$

In order to determine the exact phase-shift and the target range both in-phase and quadrature components are needed. Namely, from Eqs. (10) and (11) the overall phase can be determined as follows

$${φ}^{( l )} = {tan}^{- 1} [ \frac{〈 {\hat{i}}_{BD , Q}^{( l )} 〉}{〈 {\hat{i}}_{BD , I}^{( l )} 〉} ] .$$

Given that θ_{mod} is known by the receivers, the deterministic phase ϑ^{(l)} can be determined based on Eq. (8). The known phase is used to estimate the random phase shift.

For the receive side phase modulator shift of Δ_{φ}=0 rad, the variance of the BD photocurrent operator, defined as

$$Var ( {\hat{ι}}_{BD}^{( l )} ) = 〈 {( {\hat{ι}}_{BD}^{( l )} )}^{2} 〉 - 〈 {( {\hat{ι}}_{BD}^{( l )} )}^{2} 〉 ,$$

$$will be :$$

$$Var ( {\hat{ι}}_{BD}^{( l )} ) = {N}_{i} {N}_{s}^{( l )} + ( {N}_{i} + 1 ) ( {N}_{s}^{( l )} + 1 ) + 2 {N}_{s} {T}^{( l )} {T}^{( i )} ( {N}_{s} + 1 ) [ cos ( 2 {φ}^{( l )} ) - {cos}^{2} {φ}^{( 1 )} ] , \qquad ( 12 )$$

$$where {N}_{s}^{( l )} = ( {T}^{( i )} {N}_{s} + {N}_{b}^{( i )} ) {T}^{( l )} + {N}_{b}^{( l )} .$$

In the absence of the target, the BD photocurrent operator expectation is zero, while the corresponding variance is:

$$Var ( {\hat{ι}}_{BD , t = 0}^{( l )} ) = {N}_{i} {N}_{b}^{( l )} + ( {N}_{i} + 1 ) ( {N}_{b}^{( l )} + 1 ) = {N}_{s} {N}_{b}^{( l )} + ( {N}_{s} + 1 ) ( {N}_{b}^{( l )} + 1 ) , \qquad ( 13 )$$

$$where {N}_{i} = {N}_{s} .$$

Given that in the target detection problem the prior probabilities are not known in advance, it may be useful to apply the Neyman-Pearson criterion. In the Neyman-Pearson criterion, the maximum tolerable false alarm probability is fixed and the target detection probability is maximized.

For the proposed EA joint monostatic-bistatic target detection scheme 172, the false alarm (FA) probability is given by:

$${Q}_{FA} = \frac{1}{2} erfc ( \frac{{t}_{sh}}{\sqrt{{N}_{s} {N}_{b} + ( {N}_{s} + 1 ) ( {N}_{b} + 1 )}} ) , \qquad ( 14 )$$

where tₛₕ is the threshold determined from the tolerable FA probability, wherein the complementary error function is given by

$$erfc ( x ) = ( 2 / \sqrt{π} ) {\int }_{x}^{∞} exp ( - {u}^{2} ) du .$$

Assuming that the equal gain combining is used as the joint detection scheme for two receivers, the target detection probability is given by:

$${Q}_{D} = \frac{1}{2} erfc ( \frac{{t}_{sh} - {m}_{v}}{\sqrt{{V}^{( r )} + {V}^{( fs )}}} ) , \qquad ( 15 )$$

$$where$$

$${m}_{v} = 2 \sqrt{{T}^{( r )} {T}^{( i )} {N}_{s} ( {N}_{s} + 1 )} + 2 \sqrt{{T}^{( fs )} {T}^{( i )} {N}_{s} ( {N}_{s} + 1 )} , \qquad ( 16 )$$

$${V}^{( r )} = {N}_{i} {N}_{s}^{( r )} + ( {N}_{i} + 1 ) ( {N}_{s}^{( r )} + 1 ) - 2 {T}^{( r )} {T}^{( i )} {N}_{s} ( {N}_{s} + 1 ) ,$$

$${V}^{( fs )} = {N}_{i} {N}_{s}^{( fs )} + ( {N}_{i} + 1 ) ( {N}_{s}^{( fs )} + 1 ) - 2 {T}^{( fs )} {T}^{( i )} {N}_{s} ( {N}_{s} + 1 ) .$$

### A-III. Illustrative Numerical Results

The referent case will be a monostatic radar in which a coherent state is used to illuminate the target, in the presence of thermal (background) radiation. The density operator, in the presence of thermal radiation, has the following P-representation:

$${ρ}_{t} = \frac{1}{π {N}_{b}} \int e \frac{{\vert a - {μ}_{t} \vert}^{2}}{{N}_{b}} \vert α 〉 〈 a \vert {d}^{2} α . \qquad ( 17 )$$

In the absence of the target, (t=0) with μ₀=0. In the presence of the target, (t=1) with μ₁=μ. The parameter N_{b} denotes the average number of thermal (e.g., background) photons. The coherent state |a [symbol] can be expressed in terms of number states by |a [symbol] =e^{-|a|}^{²}^{/2}Σₙ(aⁿ/\sqrt{n!})|n [symbol] and after substitution in Eq. 17 yields:

$${ρ}_{0} = {\sum }_{n = 0}^{∞} ( 1 - v ) {v}^{n} \vert n 〉 〈 n \vert , v = {N}_{b} / ( {N}_{b} + 1 ) . \qquad ( 18 )$$

The corresponding density matrix in the presence of target is given by:

$$〈 n \vert {ρ}_{1} \vert m 〉 = \{ \begin{matrix}( 1 - v ) \sqrt{\frac{n !}{m !}} {{v}^{m} ( {μ}^{*} / N )}^{m - n} {e}^{- ( 1 - v ) {\vert μ \vert}^{2}} . & \\ {L}_{n}^{m - n} [ - {( 1 - v )}^{2} {\vert μ \vert}^{2} / v ] , & m \geq n \\ {〈 m \vert {ρ}_{k} \vert n 〉}^{*} , & m < n\end{matrix} \qquad ( 19 )$$

where |μ [symbol] denotes the state used to illuminate the target.

In (19),

$${L}_{deg}^{ord} ( \cdot )$$

is used to denote the associated Laguerre polynomials with superscript ord and subscript deg denoting the order and the degree, respectively.

For the Neyman-Pearson criterion, the optimum strategy will be to determine the eigenvalues ηₖ and eigenkets |ηₖ [symbol] of the operator ρ₁−Λρ₀ by solving the eigenvalue equation:

$$( {ρ}_{1} - {Λρ}_{0} ) \vert {η}_{k} 〉 = {η}_{k} \vert {η}_{k} 〉 , \qquad ( 20 )$$

in which the parameter Λ is determined from the maximum tolerable FA probability. This problem can be solved numerically. To reduce receiver complexity, the Helstrom threshold detector can be used, with the corresponding detection operator defined as:

$${\prod }_{H . t .} = {( {N}_{b} + 0.5 )}^{- 1} ( \hat{a} + {\hat{a}}^{†} ) , \qquad ( 21 )$$

which is related to the in-phase operator.

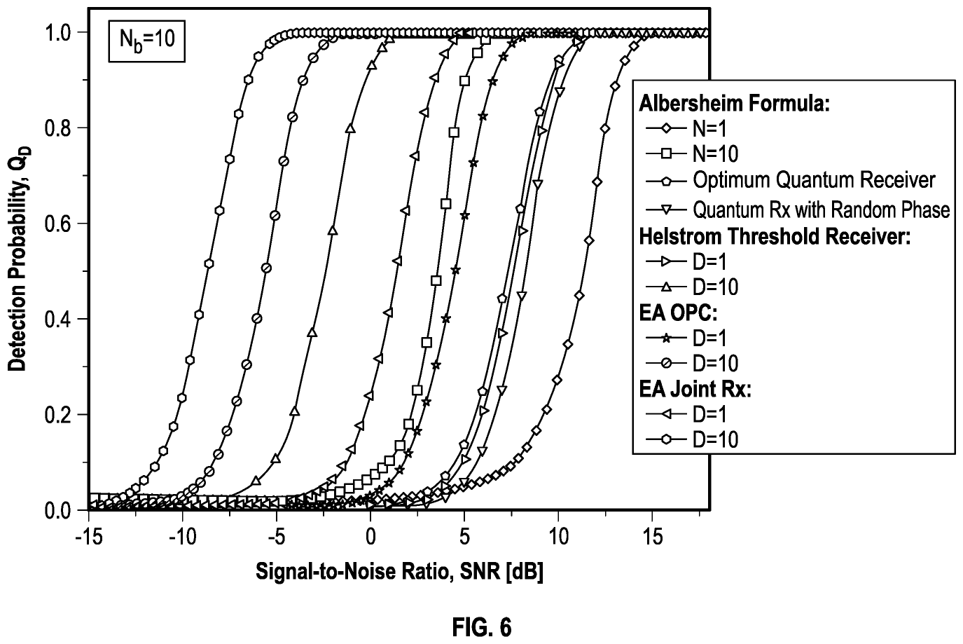

By assuming that the idler channels are ideal (e.g., by setting the corresponding transmissivities to T^{(l)}=1) in FIG. 6, the EA joint monostatic-bistatic target detection scheme implemented by the system 100 is compared against various coherent states-based schemes and EA detection scheme for monostatic radar. In some examples, the EA joint monostatic-bistatic target detection scheme can be compared in terms of detection probability vs. SNR, by setting the average number of background photons to N_{b}=10, where the false alarm probability that can be tolerated is fixed to Q_{FA}=10⁻⁶.

For completeness of presentation, the classical Albersheim's equation-based curves are provided as well for the number of samples set to N=1 and 10. For the non-classical target detection schemes the SNR is defined by Nₛ/(2N_{b}+1). The coherent states-based detection schemes under study include optimum quantum detector, quantum receiver (Rx) with the random phase, and Helstrom threshold receiver. As described below, the proposed EA joint (monostatic-bistatic) target detection scheme described herein can be seen to significantly outperform various coherent states-based detections schemes, the EA detection scheme for monostatic radar, and the classical target detection.

Given that the SPDC-based entangled source is a broadband source in FIG. 6, the improvement in SNR when the number of bosonic modes is increased to D=10 is studied. The EA joint target detection scheme implemented by the system 100 significantly outperforms the Helstrom threshold receiver with D=10 modes and classical radar detector for N=10 samples.

For the detection probability set to Q_{D}=0.95 (and false alarm probability fixed to Q_{FA}=10⁻⁶), the EA target detection scheme implemented by the system 100 for D=10 Bosonic modes outperforms Helstrom detection scheme (for the same number of Bosonic modes) by 6.16 dB, while at the same time outperforming the corresponding classical scheme with N=10 samples by even 11.29 dB. The joint EA scheme implemented by the system 100 for D=10 Bosonic modes outperforms the corresponding EA scheme for monostatic radar (also with 10 bosonic modes at Q_{D}=0.95) by 3.01 dB.

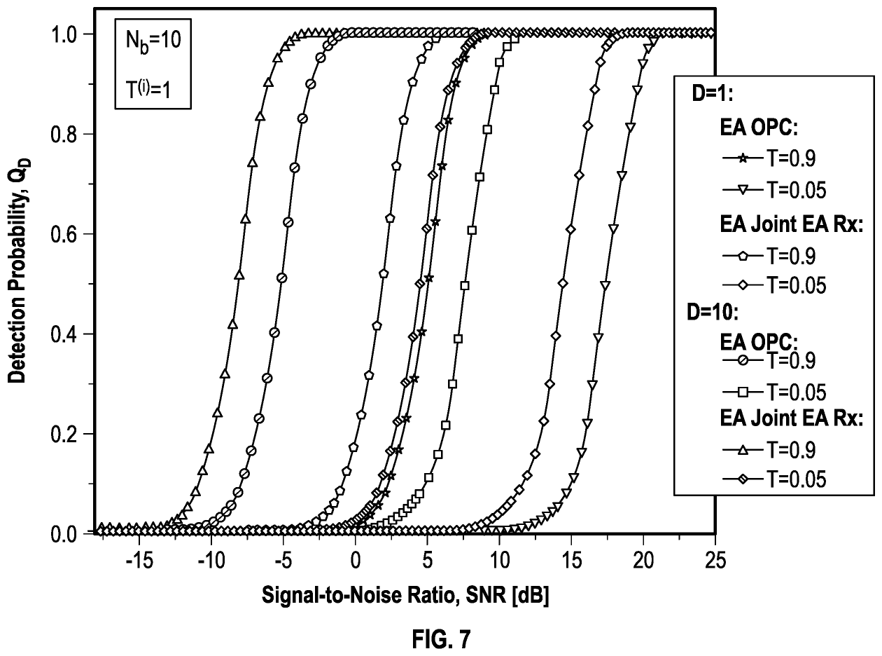

FIG. 7 illustrates the detection probability vs. SNR [dB] of the EA joint detection scheme implemented by the system 100 is evaluated by modelling both the direct return probe and forward scattered probe channels as the bosonic noisy and lossy channels with N_{b}=11 and transmissivities T^{(r)}=T^{(ƒs)}=T, where the corresponding channel models are given by Eq. (7).

Here, the ideal distribution of entanglement over the idler channels (e.g., T⁽ⁱ⁾=1 and N_{b}_{⁽ⁱ⁾}=0) is assumed. When transmissivities of the direct return probe and forward scattered probe channels are low, the use of single Bosonic mode is not sufficient because the required SNR to achieve high target detection probability is too high. On the other hand, when the number of bosonic modes is increased to 10, high target detection probabilities can be achieved even at moderate SNRs (for low channel transmissivities). For T=0.05, the EA joint detector implemented by the system 100 with 10 bosonic modes outperforms EA monostatic radar detector by 3.04 dB at QD=0.95.

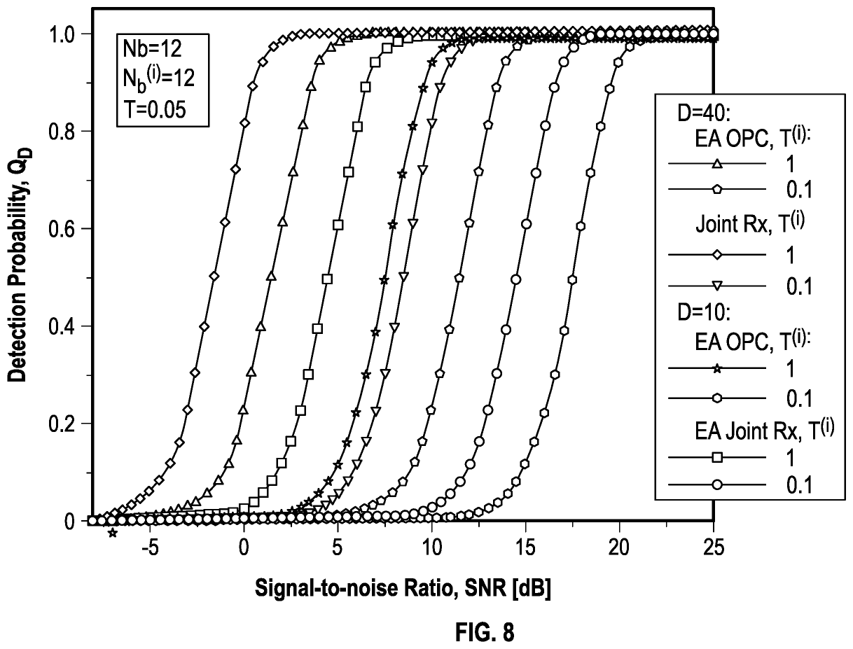

In FIG. 8, the detection probability vs. SNR [dB] of the EA joint detection scheme implemented by the system 100 is evaluated by fixing the direct return probe/forward scattered probe channel transmissivities to T^{(r)}=T^{(ƒs)}=T=0.05 and varying the transmissivity of the idler channels, wherein the idler channel model is described by Eq. (4).

In FIG. 8, the maximum tolerable false alarm probability is again set to Q_{FA}=10⁻⁶. Both signal and idler bosonic channels are under assumption of being noisy with corresponding parameters being N_{b}=12 and N_{b}_{⁽ⁱ⁾}=2, respectively. When the idler channel is noisy and lossy, the same detection probability is achieved for higher SNR values, compared to the case with perfect distribution of entanglement. To solve for this problem, the number of bosonic modes can be increased, which can be implemented based on the wideband nature of the SPDC process.

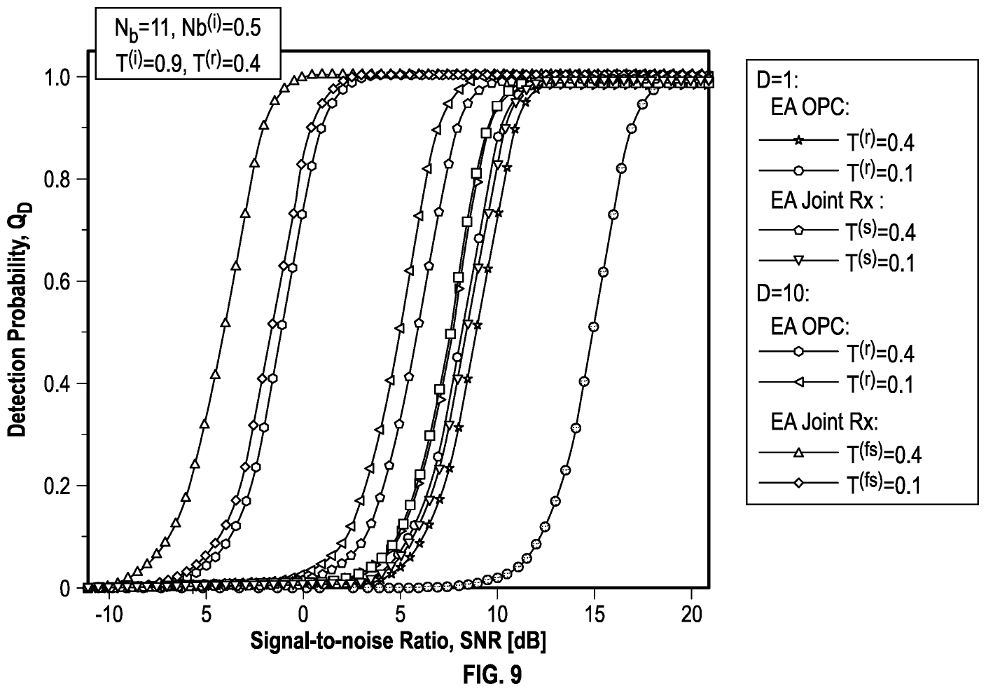

Finally, FIG. 9 illustrates the detection probability vs. SNR [dB] for the presently disclosed EA joint detection scheme for a fixed idler channel(s) transmissivity of T⁽ⁱ⁾=0.9. The direct return probe channel transmissivity is set to T(r)=0.4. while the forward scattered probe channel transmissivity is varied as T^{(fs)}∈{0.1, 0.4}. The maximum tolerable false alarm probability is again set to Q_{FA}=10⁻⁶.

In FIG. 9, the detection probability of the EA joint detection scheme implemented by the system 100 when the transmissivities of the direct return probe and the forward scattered probe channels are different, while the average number of thermal photons is set to N_{b}=11. The idler channels are considered identical but lossy and noisy [T⁽ⁱ⁾=0.9 and N_{b}_{⁽ⁱ⁾}=0.5]. The joint EA detection scheme implemented by the system 100 for T^{(r)}=0.4 and T^{(ƒs)}=0.1 for 10 bosonic modes outperforms the EA detector for monostatic radar with T^{(r)}=0.4 by even 6.49 dB at Q_{D}=0.95.

The system 100 implements an entanglement assisted joint bistatic-monostatic quantum radar detection scheme having optical phase conjugation on transmitter side and classical coherent detection on both receiver sides. The EA joint target detection scheme implemented by the system 100 has been evaluated against the coherent states-based quantum detection schemes and EA detection scheme for monostatic radar. Results show that the detection probability of the proposed EA joint target detection scheme has been significantly better than that of corresponding coherent states-based quantum detection schemes, the classical detection, and EA detection scheme for monostatic radar. The EA joint target detection scheme implemented by the system 100 has also been evaluated by assuming the imperfect distribution of entanglement and by modeling the direct return probe and forward scattered probe channels as both lossy and noisy Bosonic channels.

### B: Entanglement Assisted Bistatic Radars With Transmitter Side Optical Phase Conjugation (OPC) and Classical Coherent Detection

Entanglement is a unique quantum information processing (QIP) attribute. With the help of entanglement, systems can: (1) outperform the sensitivity of classical sensors, (2) enable communication networks with unconditional security, and (3) communicate at rates above the classical channel capacity. By distributing the entanglement at a distance, various quantum devices and modules can be interconnected, thus enabling secure distributed quantum computing and distributed quantum sensing.

One motivation behind quantum radar studies is to outperform the quantum limit of classical sensors. The potential advantages of quantum radars compared to the classical radars can be summarized as follows: better receiver sensitivity, better target detection probability in a low signal-to-noise ratio (SNR) regime, improved penetration through clouds and fog when microwave photons are used, better resilience to jamming, improved synthetic-aperture radar imaging quality, the quantum radar signals are more difficult to detect compared to classical counterparts, and quantum radars have higher cross-section, to mention few. Unfortunately, quantum radars have to date been significantly more challenging to implement. Two popular quantum radar designs are: (i) interferometric quantum radar, with the concept being very similar to the quantum interferometry, and (ii) the quantum radar employing the quantum illumination sensing concept.

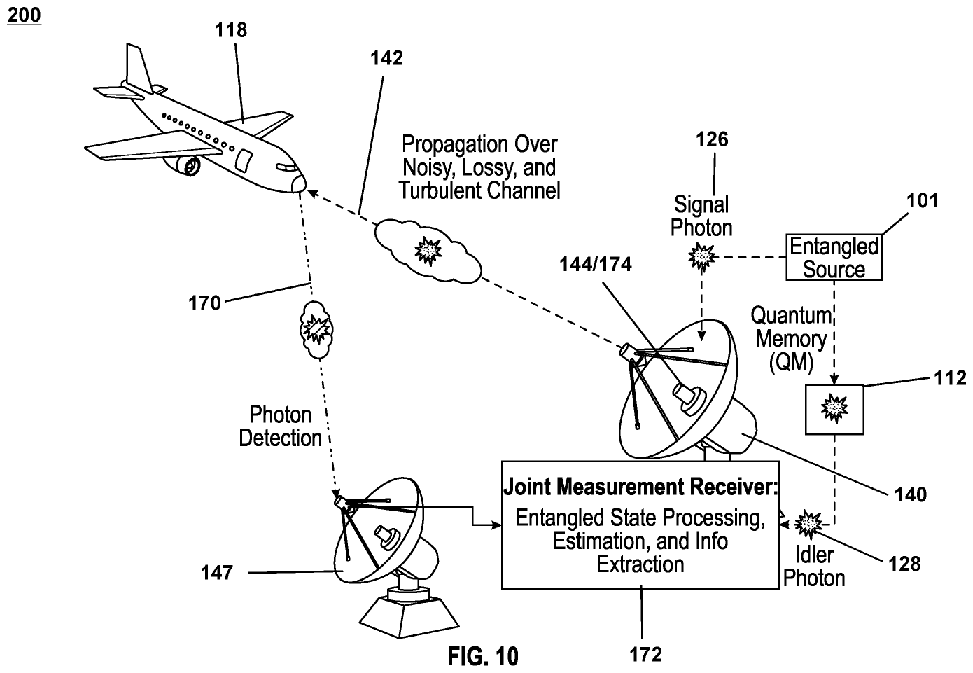

Aspects of the present disclosure provide systems and methods for a system 200 that implements entanglement assisted (EA) bistatic quantum radar detection, whose operational principle is illustrated in FIG. 10. In the example of FIG. 10, an entangled source generates an entangled pair of photons (124), e.g., the signal 126 and idler 128 photons. The idler photon is kept in the quantum memory 112 of the receiver 172, while the signal photon is transmitted with the help of a wide field of view (FOV) expanding telescope 144 over a noisy, lossy, and atmospheric turbulent channel towards the target 118. The reflected photon 148 is collected by a compressing telescope and detected by the entanglement assisted (EA) receiver 147 and quantum correlation is exploited to improve the target detection probability.

To improve target detection probability, the system 200 employs the optical phase conjugation (OPC) on the transmitter side 154 and classical coherent detection on the receiver side. The EA target detection scheme employed by the system 200 significantly outperforms coherent states-based quantum detection and classical counterparts. The EA target detection scheme employed by the system 200 is evaluated by modelling the transmitter-target-receiver (main) channel as the lossy and noisy Bosonic channel and assuming that the distribution of entanglement over the idler channel is imperfect.

The organization of the remainder of Section B is provided below. The EA radar concept is introduced in Sec. B-1. Both signal and idler channels are modeled as lossy and noisy Bosonic channels. The EA radar scheme implemented by the system 200, employing the OPC on transmitter side and coherent detection on receiver side, is described in Sec. B-22. Sec. B-III describes an example evaluation of the detection probability performances of the proposed EA target detection scheme and compares it against coherent states-based quantum detection schemes.

### B-1: Entanglement Assisted Quantum Radars

Entanglement assisted target detection implemented by the system 200 employs Gaussian states generated through the continuous-wave spontaneous parametric down conversion (SPDC) process. The SPDC-based entangled source is broadband source containing D=TₘₑₐₛB i.i.d. signal-idler photon pairs, where Tₘₑₐₛ is the measurement interval and B is the phase-matching SPDC bandwidth. Each signal-idler photons pair, with corresponding signal and idler creation operators denoted by

$${\hat{a}}_{s}^{†} and {\hat{a}}_{i}^{†} ,$$

respectively, is in fact a two-mode squeezed vacuum (TMSV) state whose representation in Fock basis is given by:

$${{{\vert Ψ 〉}_{s , i} = \frac{1}{\sqrt{{N}_{s} + 1}} {\sum }_{n = 0}^{∞} {( \frac{{N}_{s}}{{N}_{s} + 1} )}^{n / 2} \vert n 〉}_{s} \vert n 〉}_{i} , where {N}_{s} = 〈 {\hat{a}}_{s}^{†} {\hat{a}}_{s} 〉 = 〈 {\hat{a}}_{i}^{†} {\hat{a}}_{i} 〉$$

denotes the mean photon number per mode.

The signal-idler entanglement is specified by the phase-sensitive cross-correlation (PSCC) coefficient [symbol] âₛâᵢ [symbol] =\sqrt{Nₛ(Nₛ+1)}, which can be interpreted as the quantum limit. The TMSV state is a pure maximally entangled zero-mean Gaussian state with the following Wigner covariance matrix:

$${Σ}_{TMSV} = [ \begin{matrix}( 2 {N}_{s} + 1 ) 1 & 2 \sqrt{{N}_{s} ( {N}_{s} + 1 ) Z} \\ 2 \sqrt{{N}_{s} ( {N}_{s} + 1 ) Z} & ( 2 {N}_{s} + 1 ) 1\end{matrix} ] , \qquad ( 23 )$$

where Z=diag (1,−1) denotes the Pauli Z-matrix and 1 denotes the identity matrix.

In the low-brightness regime Nₛ<<1, the PSCC is [symbol] âₛâᵢ [symbol] ≈\sqrt{Nₛ} that is much larger than the corresponding classical limit Nₛ. As described earlier, referring back to FIG. 10, the entangled source 101 is used on the transmitter side to generate a quantum correlated signal photon 126 (e.g., probe 142) and an idler photon 128 (e.g., local reference). The signal photon is transmitted over a noisy, lossy, and atmospheric turbulent channel towards the target 118.

The reflected photon 170 (e.g., also known as the radar return) is detected by the radar's receiver 147, and quantum correlation between radar return and retained reference (e.g., idler photon) is exploited to improve the receiver sensitivity. The interaction between the probe (e.g., signal) photon and the target can be described by a beam splitter of transmissivity T. Therefore, the radar transmitter-target-radar receiver (e.g., main) channel can be modeled as a lossy thermal Bosonic channel.

$${\hat{a}}_{Rx} ( φ ) = \sqrt{T} {e}^{- j φ} {\hat{a}}_{s} + \sqrt{1 - T} {\hat{a}}_{b} , \qquad ( 24 )$$

where â_{b} is a background (thermal) state photon number being

$$( 1 - T ) 〈 {\hat{a}}_{b}^{†} {\hat{a}}_{b} 〉 = {N}_{b} .$$

The signal-mode phase shift introduced by the target and channel is denoted by φ. The idler-mode channel is also modeled as the lossy and noisy Bosonic channel:

$${\hat{a}}_{Rx , idler} = \sqrt{{T}_{i}} {\hat{a}}_{i} + \sqrt{1 - {T}_{i}} {\hat{a}}_{bi} , \qquad ( 25 )$$

where Tᵢ is transmissivity of the idler channel and â_{bi} is the annihilation operator of the background (e.g., thermal) mode of the idler channel with the mean photon number being

$$( 1 - T ) 〈 {\hat{a}}_{bi}^{†} {\hat{a}}_{bi} 〉 = {N}_{bi} .$$

The radar returned probe and the retained reference (e.g., stored idler) can be described by the following covariance matrix:

$${Σ}_{t} = [ \begin{matrix}( 2 {N}_{s} + 1 ) 1 & 2 \sqrt{{TT}_{i} {N}_{s} ( {N}_{s} + 1 )} Z {δ}_{1 t} \\ 2 \sqrt{{TT}_{i} {N}_{s} ( {N}_{s} + 1 )} Z {δ}_{1 t} & ( 2 {N}_{s} + 1 ) 1\end{matrix} ] , where {T}_{s}^{′} = ( {T}_{i} {N}_{s} + {N}_{bi} ) T + {N}_{b} . \qquad ( 26 )$$

The target indicator is denoted by t, where the absence of the target is denoted by t=0 (and in this case the return signal does not contain the probe, just the background noise) and the covariance matrix is diagonal. The presence of the target is denoted by t=1 and antidiagonal terms (e.g., representing the quantum correlation between the signal and idler, are non-zero in this case).

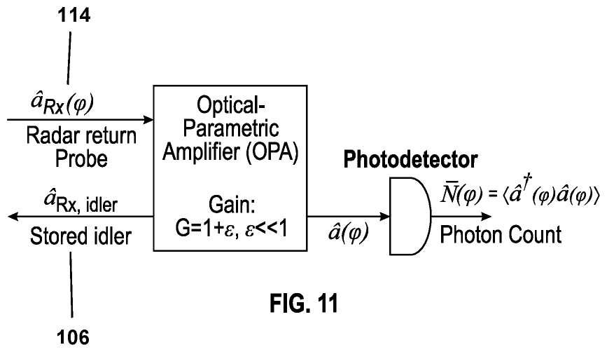

The joint measurement receiver 172 may use the optical parametric amplifier (OPA), shown in FIG. 11, with a low gain G−1=ε<<1, to obtain:

$$\hat{a} ( φ ) = \sqrt{G} {\hat{a}}_{Rx , idler} + \sqrt{G - 1} {\hat{a}}_{Rx}^{†} ( φ ) \qquad ( 27 )$$

for each signal-idler pair of a given mode.

The direct detection of the OPA has a following mean photon number given by N̅(φ)= [symbol] â^{†}(φ)â(φ) [symbol] . With the help of OPA, the entanglement assisted receiver for ideal distribution of the idler (Tᵢ=1) can provide a maximum 3 dB improvement over a corresponding classical receiver. However, in the presence of experimental imperfections the improvement may be reduced down to 1 dB.

Given that the OPC receiver has better sensitivity than the OPA receiver, aspects of the present disclosure are directed to the study of an EA target detection scheme employing the OPC. Moreover, the EA communication employing the OPC-based receiver has been experimentally demonstrated. A key difference of the target detection scheme implemented by the system 200 is that the OPC operation is performed on the transmitter side, rather than being performed on the receiver side (e.g., as in existing implementations), while classical coherent detection is applied on receiver side. Existing implementations have also demonstrated results that were evaluated in terms of probability of error, rather than the detection probability that is more relevant in radar applications. It is noted that the closed-form expression for the detection probability is derived herein and will be described in greater depth below. Additionally, it is assumed that the distribution of entanglement is not perfect.

In some aspects, by moving the OPC operation to transmitter side, the system 200 can: (i) extend the transmission distance because the low-brightness regime can be redefined as TNₛ<<1, (ii) integrate the EA transmitter with modulator on the same chip 160, and (iii) reduce the complexity for multistatic radar applications (e.g., because the OPC will be performed only once on the transmitter side, as opposed to performing the OPC on the receiver side which requires that each receiver will need the nonlinear device to perform the OPC). In principle, the maximum entangled states are not needed to achieve the quantum advantage. Various coherent states-based quantum detection schemes outperform the classical target detection as described herein. However, by using the entangled states, additional improvements are possible. Given that the TMSV states can straightforwardly be generated through the SPDC process, and that corresponding theory is well developed, it can be preferable to use the TMSV states in the EA target detection scheme implemented by the system 200.

### B-II: Entanglement Assisted Radar Detection With Transmitter Side Optical Phase Conjugation and Coherent Detection

This section provides details about the system 200 that employs an entanglement assisted radar detection concept (e.g., the system 200 shown in FIG. 11), which in some aspects can be based on the recently proposed EA communication system (see, for example, commonly owned U.S. Provisional Patent Application No. U.S. 63/352,540, the contents of which are herein incorporated by reference in their entirety).

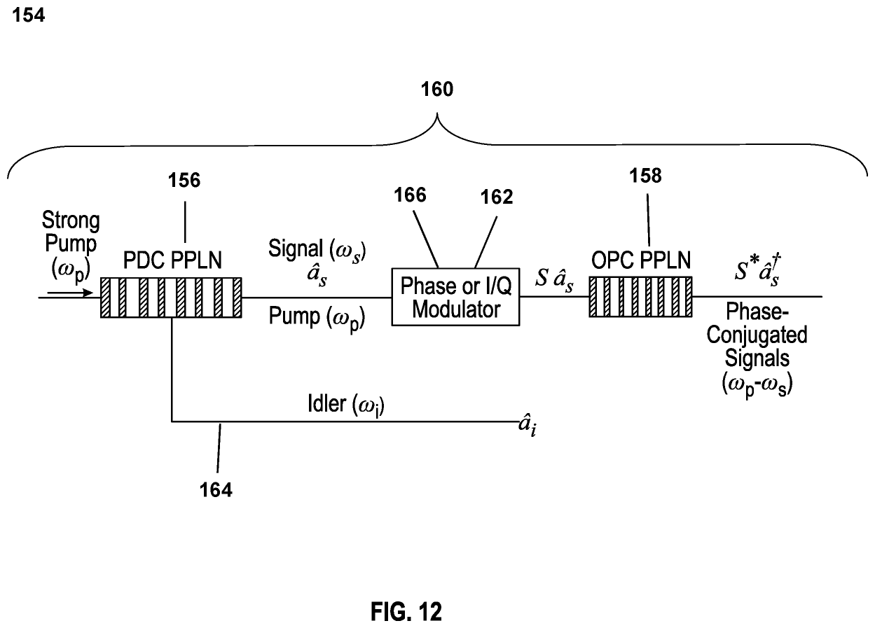

The integrated entanglement assisted transmitter 108, based on LiNbO₃ technology and performing optical phase conjugation on the transmitter side, is shown in FIG. 12. The phase or I/Q modulator can be optional. In FIG. 12, s is used to denote a signal constellation point imposed by either a phase modulator or an I/Q modulator 162 and 166. For instance, for M-ary PSK, s=exp(jθₘ).

To perform the OPC 158 through the difference frequency generation (DFG), the system 200 employs the periodically poled LiNbO₃ (PPLN) waveguide. The SPDC 156 concept is employed in the first PPLN waveguide to generate signal-idler photon pairs, which get separated by Y-junction. The DFG interaction of the pump photon ωₚ and signal photon ωₛ takes place in the second PPLN to generate the phase-conjugated photon at ω_{OPC}=ωₚ−ωₛ.

As an illustrative example, assuming that the strong pump laser diode at λₚ=780 nm is used, through the SPDC process the following signal-idler pair can be generated: the signal photon at wavelength λₛ=1585.8 nm and the idler photon at wavelength λᵢ=1535 nm. In the OPC PPLN waveguide, the signal photon is interacted with the pump photon through the DFG process to obtain the phase-conjugated (PC) signal photon at wavelength λ_{s.PC}=1/(1/λₚ−1/λₛ)=1530 nm, which is the same as the idler photon wavelength.

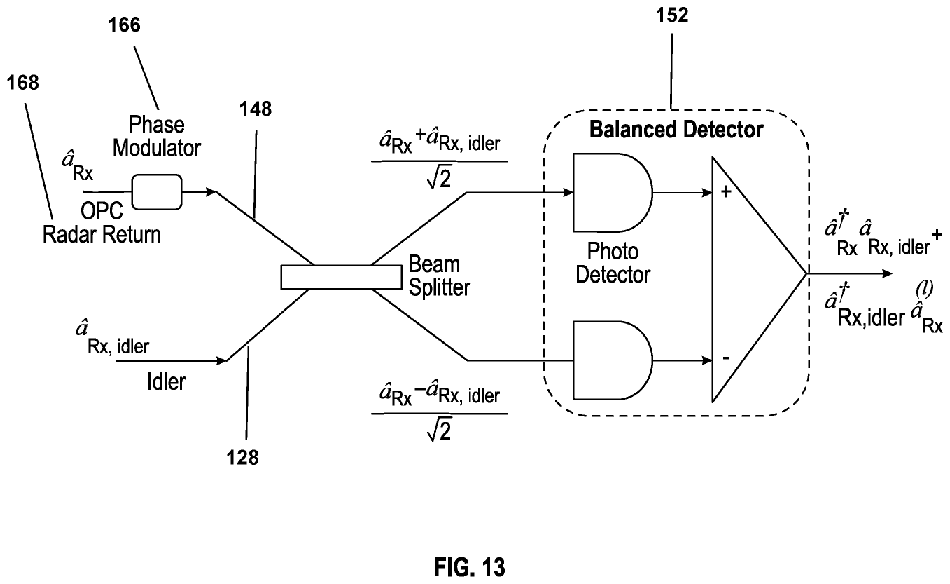

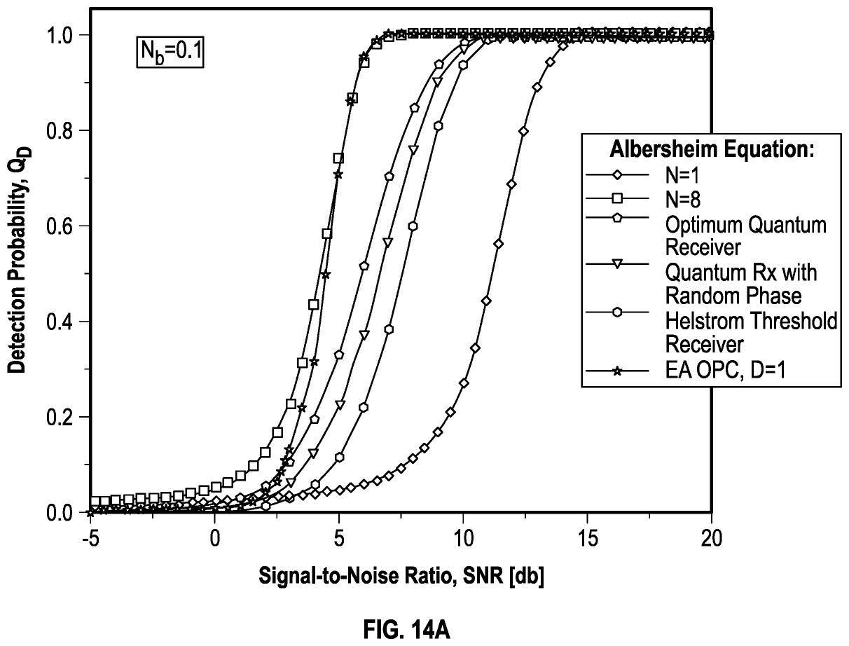

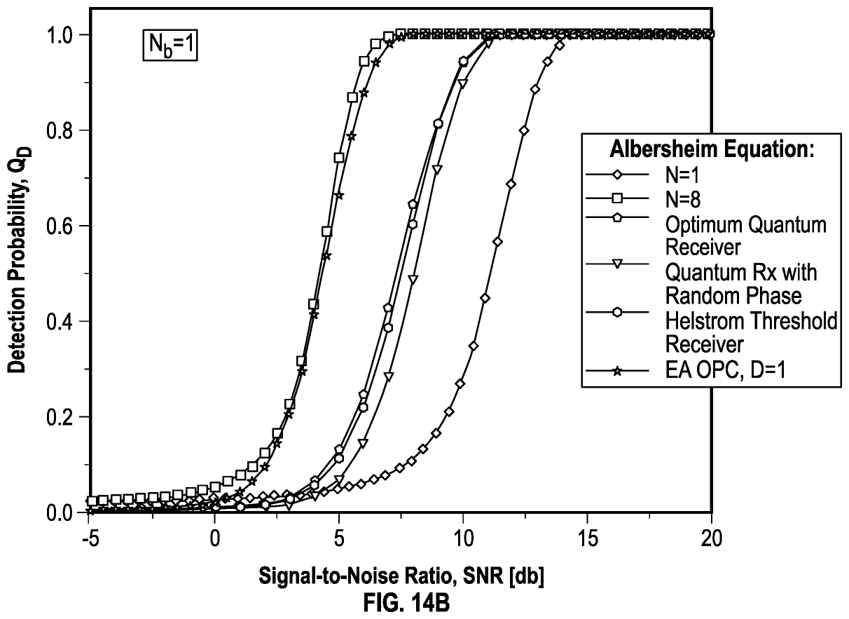

Therefore, by performing the OPC on transmitter side, conventional-classical balanced coherent detection receiver is applicable on the receiver side, with one such receiver illustrated in FIG. 13. As illustrated, the OPC radar return probe and idler modes are mixed on the balanced beam splitter, followed by two photodetectors. The idler mode serves as a local laser signal for homodyne coherent detection.

For the transmit side OPC, the main channel model becomes:

$${\hat{a}}_{Rx} ( φ ) = \sqrt{T} {e}^{j φ} {\hat{a}}_{s}^{†} + \sqrt{1 - T} {\hat{a}}_{b} , \qquad ( 28 )$$

where the overall phase φ includes three components:

$$φ = {θ}_{m} + ϑ + ϕ , \qquad ( 29 )$$

where θₘ is the modulation phase (when M-ary PSK is used), while ϑ denotes the phase-shift introduced by the target.

Assuming that transmitter and receiver are in close proximity, phase-shift introduced by the target (e.g., the phase-shift ϑ, above) is related to the distance d from the target by ϑ=2kd, with k being the wave number related to the wavelength λ by k=2π/λ. Finally, ϕ is the random phase shift introduced by the channel. The sequence encoded on transmitter side is used as a pilot sequence for estimation and cancelation of the random phase shift.

The operation principle of the entanglement assisted bistatic radar (e.g., illustrated in FIG. 11) is the same as previously described above with respect to FIG. 11.

The balanced detector (BD) photocurrent operator (assuming that the photodiode responsivity is 1 A/W) is given by:

$${\hat{l}}_{BD} = {\hat{a}}_{Rx , idler}^{( l )} + {\hat{a}}_{Rx , idler}^{†} {\hat{a}}_{Rx} . \qquad ( 30 )$$

For the receive side phase modulator shift of Δ_{φ}=0 rad (e.g., as illustrated in FIG. 13), in the presence of the target, the following BD photocurrent operator expectation is obtained:

$$〈 {\hat{l}}_{BD , I} 〉 = 2 \sqrt{{T}_{i} {TN}_{s} ( {N}_{s} + 1 )} cos φ , \qquad ( 31 )$$

On the other hand, for the receive side phase modulator shift of Δ_{φ}=−π/2 rad, in the presence of target, following BD photocurrent operator expectation is obtained:

$$〈 {\hat{ι}}_{BD , Q} 〉 = 2 \sqrt{{T}_{i} {TN}_{s} ( {N}_{s} + 1 )} sin φ . \qquad ( 32 )$$

Both in-phase and quadrature components may be needed in order to determine the exact phase-shift and the target range. Namely, from Eqs.

$$φ = {tan}^{1} [ \frac{〈 {\hat{i}}_{BD , Q} 〉}{〈 {\hat{i}}_{BD , I} 〉} ] .$$

(31) and (32), the overall phase can be determined as follows The known phase is used to estimate the random phase shift. Given that θₘ is known by the bistatic receiver, the deterministic phase ϑ can be determined based on Eq. (29). The known phase is used to estimate the random phase shift ϕ.

For the receive side phase modulator shift of Δ_{φ}=0 rad, the variance of the BD photocurrent operator, defined as Var(î_{BD})= [symbol] î_{BD}² [symbol] − [symbol] î_{BD} [symbol] ², will be:

$$Var ( {\hat{ι}}_{BD} ) = {N}_{i} {N}_{s}^{′} + ( {N}_{i} + 1 ) ( {N}_{s}^{′} + 1 ) + 2 {N}_{s} {TT}_{i} ( {N}_{s} + 1 ) [ cos ( 2 φ ) - 2 {cos}^{2} φ ] , \qquad ( 33 )$$

$$where$$

$${N}_{s}^{′} = ( {T}_{i} {N}_{s} + {N}_{bi} ) T + {N}_{b} .$$

In the absence of the target, the BD photocurrent operator expectation is zero, while the corresponding variance is:

$$\begin{matrix}Var ( {\hat{ι}}_{BD}^{t = 0} ) = {N}_{i} {N}_{b} + ( {N}_{i} + 1 ) ( {N}_{b} + 1 ) \\ = {N}_{s} {N}_{b} + ( {N}_{s} + 1 ) ( {N}_{b} + 1 ) ,\end{matrix} \qquad ( 34 )$$

based on the fact that Nᵢ=Nₛ.

Given that in the target detection problem a priori probabilities are not known, the Neyman-Pearson criterion can be applied to set the maximum tolerable false alarm probability and maximize the detection probability.

For example, for the proposed EA target detection scheme, the false alarm (FA) probability is given by:

$${Q}_{FA} = \frac{1}{2} erfc ( \frac{{t}_{sh}}{\sqrt{{N}_{s} {N}_{b} + ( {N}_{s} + 1 ) ( {N}_{b} + 1 )}} ) , \qquad ( 35 )$$

where tₛₕ is the threshold determined from the tolerable FA probability.

The complementary error function is defined by

$$erfc ( x ) = ( 2 / \sqrt{π} ) {\int }_{x}^{∞} exp ( - {u}^{2} ) du .$$

On the other hand, the detection probability is given by:

$${Q}_{D} = \frac{1}{2} erfc ( \frac{{t}_{sh} - 2 \sqrt{{TT}_{i} {N}_{s} ( {N}_{s} + 1 )}}{\sqrt{{N}_{i} {N}_{s}^{′} + ( {N}_{i} + 1 ) ( {N}_{s}^{′} + 1 ) - 2 {TT}_{i} {N}_{s} ( {N}_{s} + 1 )}} ) , \qquad ( 36 )$$

### B-III: Illustrative Numerical Results

The referent case will be the case in which a coherent state is used to illuminate the target, in the presence of background (e.g., thermal) radiation. The density operator, in the presence of thermal radiation, has the following P-representation:

$${ρ}_{t} = \frac{1}{π {N}_{b}} \int e \frac{{\vert a - {μ}_{t} \vert}^{2}}{{N}_{b}} \vert α 〉 〈 α \vert {d}^{2} α . \qquad ( 37 )$$

wherein in the absence of the target, (t=0) with μ₀=0, while in the presence of the target, (t=1) with μ₁=μ. As before, N_{b} denotes the average number of thermal (e.g., background) photons.

The coherent state |a [symbol] can be expressed in terms of number states as follows |a [symbol] =e^{-|a|}^{²}^{/2}Σₙ(aⁿ/\sqrt{n!})|n [symbol] , and after substitution in (37) yields:

$${ρ}_{0} = {\sum }_{n = 0}^{∞} ( 1 - v ) {v}^{n} \vert n 〉 〈 n \vert , v = {N}_{b} / ( {N}_{b} + 1 ) . \qquad ( 38 )$$

In the presence of the target, the corresponding density matrix can be described as:

$$( 39 )$$

$$〈 n \vert {ρ}_{1} \vert m 〉 = \{ \begin{matrix}( 1 - v ) \sqrt{\frac{n !}{m !}} {{v}^{m} ( {μ}^{*} / )}^{m - n} {e}^{- ( 1 - ν ) {\vert μ \vert}^{2}} \cdot {L}_{n}^{m - n} [ - {( 1 - v )}^{2} {\vert μ \vert}^{2} / v ] , & m \geq n \\ {〈 m \vert {ρ}_{k} \vert n 〉}^{*} , & m < n\end{matrix}$$

where |μ [symbol] is the state used to illuminate the target.

In (39),

$${L}_{d}^{o} ( \cdot )$$

is used to denote the associated Laguerre polynomials with subscript d and superscript o denoting the degree and order, respectively. An optimum strategy for the Neyman-Pearson criterion can be found based on determining the eigenvalues ηₖ and eigenkets |ηₖ [symbol] of the operator ρ₁−Λρ₀ using the following eigenvalue equation:

$$( {ρ}_{1} - Λ {ρ}_{0} ) \vert {η}_{k} 〉 = {η}_{k} \vert {η}_{k} 〉 , \qquad ( 40 )$$

wherein the parameter Λ is determined from the maximum tolerable FA probability. This problem has been solved numerically.

To reduce complexity, the Helstrom threshold detector can be used, with the corresponding detection operator:

$${\prod }_{H . t .} = {( {N}_{b} + 0.5 )}^{- 1} ( \hat{a} + {\hat{a}}^{†} ) , \qquad ( 41 )$$

being related to the in-phase operator.

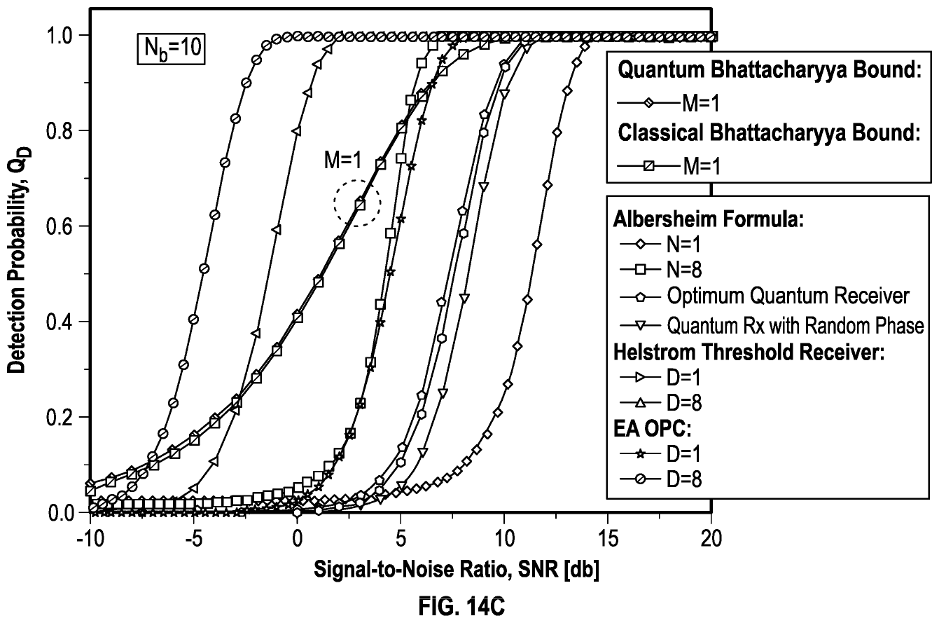

By setting T=Tᵢ=1, in FIG. 14 the proposed EA target detection scheme is compared against various coherent states-based schemes, in terms of detection probability vs. signal-to-noise ratio (SNR), for the average number of background photons being N_{b}=0.1 [e.g., in FIG. 14(a)], N_{b}=1 [e.g., in FIG. 14(b)], and N_{b}=10 [e.g., in FIG. 14(c)], wherein the false alarm probability that can be tolerated is set to Q_{FA}=10⁻⁶.

The classical Albersheim's equation-based plot is provided as well for the number of samples being N=1 and 8. The SNR for non-classical target detection schemes is defined by Nₛ/(2N_{b}+1). The following three coherent states-based detection schemes are considered: optimum quantum detector, quantum receiver (Rx) in which the phase is random, and Helstrom threshold receiver. As illustrated, the proposed EA target detection scheme outperforms various coherent states-based detections schemes and significantly outperforms the classical target detection.

As the average number of thermal photons increases, it appears that Helstrom threshold detection scheme performs comparable to the optimum quantum detection scheme, see for instance FIG. 14(b). Another observation is that for N_{b}=0.1 the Helstrom threshold detector performs worse than quantum receiver with random phase, while for N_{b}=1 and 10 it performs better. For N_{b}=10, also provided are both quantum and classical Bhattacharyya bounds, assuming that M=1 TMSV state is used, which are strictly speaking tight bounds only in a high-SNR regime.

Given that the SPDC-based entangled source is a broadband source in FIG. 14(c), also studied is the improvement when the number of bosonic modes is increased to D=8. The proposed EA target detection scheme significantly outperforms the Helstrom threshold receiver with D=8 and classical radar detector for N=8. For the detection probability of Q_{D}=0.95 (and false alarm probability of Q_{FA}=10⁻⁶), the EA target detection scheme for D=8 Bosonic modes outperforms Helstrom detection scheme (also with D=8) by 3.12 dB, while at the same time outperforming the corresponding classical scheme with N=8 samples by even 8.03 dB.

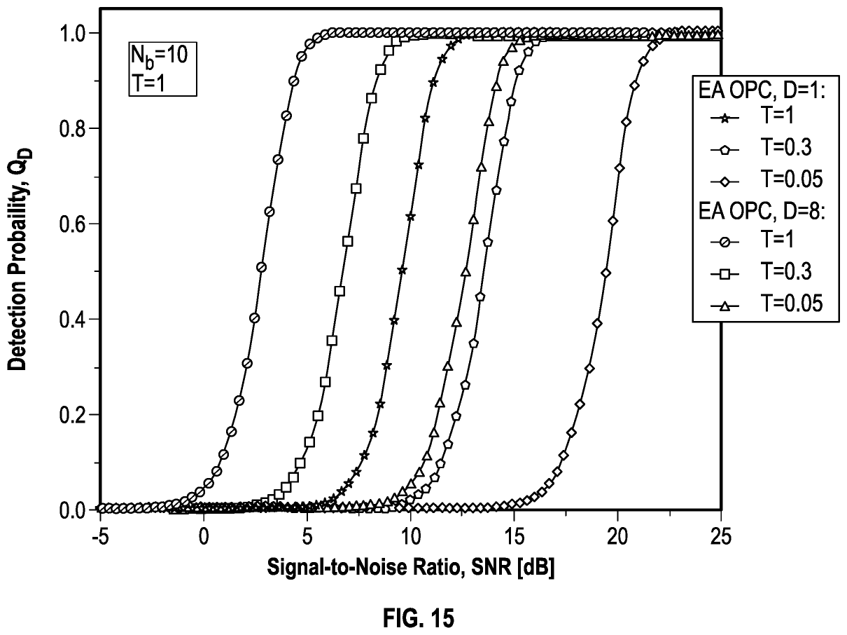

In FIG. 15, the EA scheme's detection probability vs. SNR is evaluated by observing now the Bosonic main (signal) channel model, described by Eq. (28). Here it is assumed that the ideal distribution of entanglement over the idler channel exists (e.g., Tᵢ=1 and N_{bi}=0), while the main channel is considered noisy with parameter Ny being set to 10. For low transmissivities of the main channel, the use of single Bosonic mode is not sufficient because the required SNR to achieve high target detection probability is way too high. On the other hand, when eight Bosonic modes are employed, high target detection probabilities are possible even for moderate SNRs when the channel transmissivity is very low.

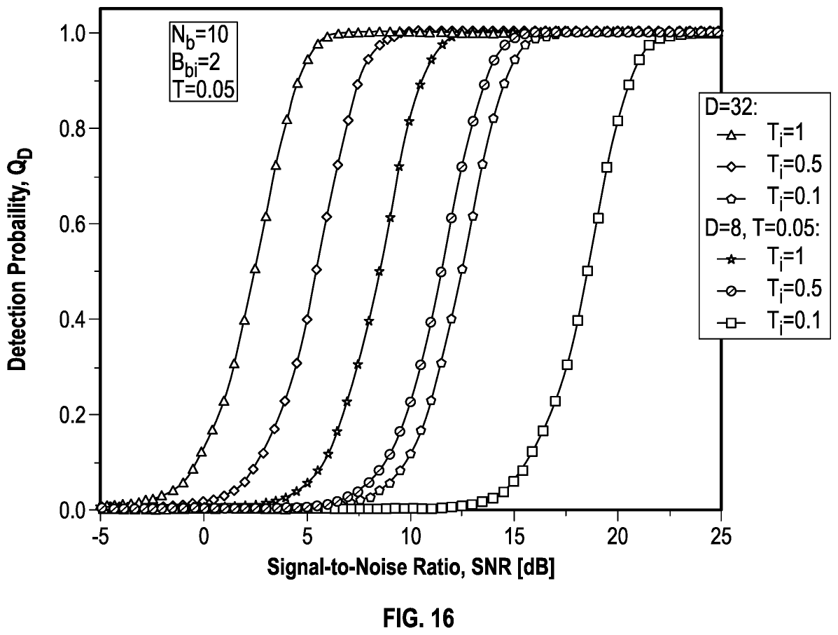

In FIG. 16, the proposed EA scheme's detection probability vs. SNR is evaluated by fixing main (signal) channel transmissivity to T=0.05 and varying the transmissivity of the idler channel, with the corresponding channel model being described by Eq. (25). Both main (signal) and idler bosonic channels are considered noisy with corresponding parameters being N_{b}=10 and N_{bi}=2, respectively. When the idler channel is noisy and lossy, the same detection probability is achieved for higher SNR values, compared to the case with ideal entanglement distribution. To compensate for this problem, the number of bosonic modes can be increased, which can be implement based on the wideband nature of the SPDC process.

The system 200 described herein can be used to implement one or more aspects of entanglement assisted bistatic quantum radar detection. Described and proposed herein is an EA radar detection scheme employing optical phase conjugation (OPC) on the transmitter side and classical coherent detection on the receiver side.

The proposed EA target detection scheme has been evaluated against the coherent states-based quantum detection schemes. It has been shown that the detection probability of the proposed EA target detection scheme is significantly better than that of corresponding coherent states-based quantum detection schemes, as well as that of classical detection. The proposed scheme has been also evaluated by assuming the imperfect distribution of entanglement and by modeling the radar return channel as the lossy and noisy Bosonic channel.

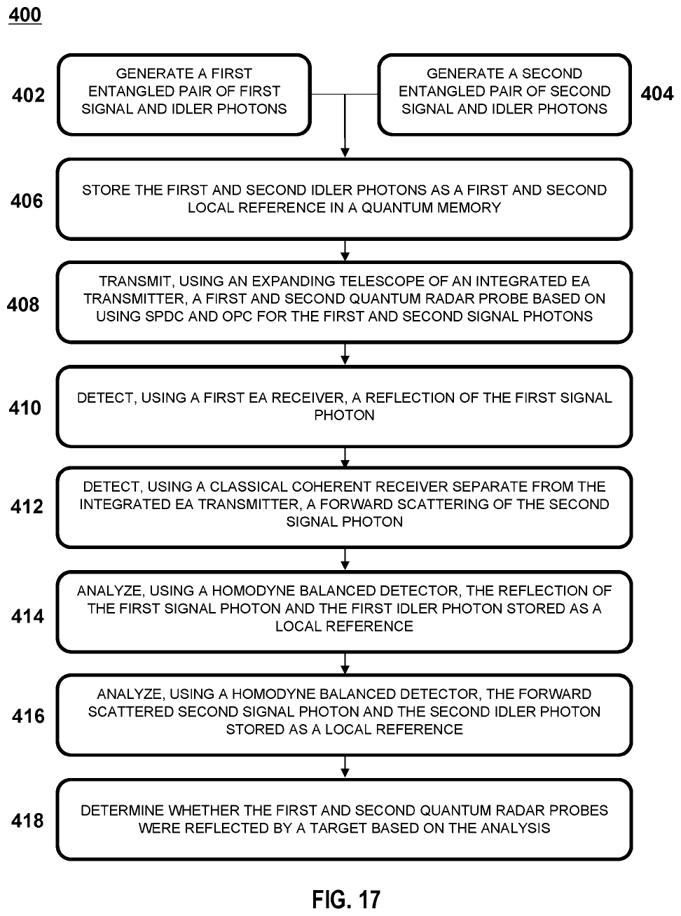

FIG. 17 is an example method associated with the system described herein. The method 400, provides example non-limiting steps including blocks 402, 404, 406, 408, 410, 412, 414, 416, and 418.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method comprising:
generating an entangled pair of photons comprising a signal photon and an idler photon;
transmitting, using an integrated entanglement assisted (EA) transmitter, a quantum radar probe based on the signal photon of the entangled pair, wherein the integrated EA transmitter generates the radar probe by performing optical phase conjugation (OPC) for the signal photon;
storing the idler photon of the entangled pair as a local reference in a quantum memory;
detecting a radar return, wherein the radar return is associated with a reflection of the quantum radar probe;
analyzing the reflection of the quantum radar probe and the idler photon stored as the local reference; and
based on the analyzing, determining whether the quantum radar probe was reflected by a target.

2. The method of claim 1, wherein the entangled pair of photons is generating using an entangled source, wherein the entangled source performs continuous-wave spontaneous parametric down conversion (SPDC).

3. The method of claim 1, wherein the radar return is detected using one or more receivers implementing classical coherent detection, such that OPC is performed only on a transmitter side, thus reducing overall system complexity and cost.

4. A method comprising:
generating a first entangled pair of photons comprising a first signal photon and a first idler photon;
generating a second entangled pair of photons comprising a second signal photon and a second idler photon;
storing the first and second idler photons as a first and second local reference, respectively, in a quantum memory;
transmitting, using a first integrated entanglement assisted (EA) transmitter:
a first quantum radar probe generated based on performing continuous-wave spontaneous parametric down conversion (SPDC), followed by optical phase conjugation (OPC) for the first signal photon, wherein the transmitting is performed using an expanding telescope; and
a second quantum radar probe generated based on performing the SPDC, followed by the OPC for the second signal photon, wherein the transmitting is performed using an expanding telescope;
detecting, using the first EA receiver, a reflection of the first signal photon;
detecting, using a classical coherent receiver separate from the first integrated EA transmitter, a forward scattering of the second signal photon;
analyzing the reflection of the first signal photon and the first idler photon stored as local reference using a homodyne balanced detector, and analyzing the forward scattered second signal photon and the second idler photon stored as local reference using the homodyne balanced detector; and
based on the analyzing, determining whether the first and second quantum radar probes were reflected by a target.

5. The method of claim 4, wherein:
the first integrated EA receiver detects the reflection of the first signal photon using classical coherent detection;
the classical coherent receiver detects the forward scattered second signal photon using classical coherent detection; and
OPC is performed only on a transmitter side of the first integrated EA transceiver.

6. The method of claim 5, wherein the OPC is performed on an EA transmitter side such that:
an SPDC module is integrated with an OPC module on a same chip; and
the transmitter integrates an electro-optical modulator located between the SPDC and OPC modules in order to impose a common sequence to be used on an EA receiver side to facilitate the determination of a target range.

7. The method of claim 4, wherein one or more of the first idler photon and the second idler photon can be stored using a variable optical delay line.

8. The method of claim 5, wherein a delay time between the signal and idler modes is determined based on the common sequence imposed by the electro-optical modulator by cross-correlating the detected sequence with the transmitted common sequence.

9. The method of claim 8, wherein the electro-optical modular comprises a PSK modulator.

10. The method of claim 4, wherein multiple EA receivers detecting multiple reflected components are used.

11. The method of claim 10, wherein the multiple EA receivers are used to detect multiple forward scattered components.

12. The method of claim 10, further comprising combining outputs of the multiple EA receivers in a joint receiver in order to improve overall SNR.

13. The method of claim 4, wherein multiple transmit apertures within the same expanding telescope are used to illuminate different portions of the target and ensure statistical independence of different reflections or scattered modes such that the spatial diversity can be utilized.
